(19) United States
(12) Patent Application Publication
(10) Pub. No.: US 2006/0080010 A1
(43) Pub. Date: Apr. 13, 2006

(54) Device for detecting impacts on aeronautic propeller blades

(75) Inventor: Robert Gaiani, Figeac (FR)

Correspondence Address: OHLANDT, GREELEY, RUGGIERO & PERLE, LLP, ONE LANDMARK SQUARE, 10TH FLOOR, STAMFORD, CT, 06901, US

(73) Assignee: RATIER FIGEAC

(21) Appl. No.: 10/514,949

(22) PCT Filed: May 22, 2002
(86) PCT No.: PCT/FR02/01727

§ 371 Date: Aug. 15, 2005

(51) Int. Cl. G01M 17/00

(52) U.S. Cl. 701/29; 701/35

(57) ABSTRACT

A device for detecting and recording impacts along several axes on an aeronautic propeller blade is provided. The device has an accelerometer integrated inside an aeronautic propeller blade root end and an electronic module for recording during its life span any occurrence of impacts at various predetermined levels.

The present invention concerns the detection of impacts on aeronautic propeller blades.

The object of the invention is to propose a device permitting knowing, over the service life of a blade, during planned maintenance or in the case of an incident, whether the blade had been subjected to impacts beyond the levels normally encountered in normal use. The invention proposes a reliable and autonomous means for detecting and recording any abnormal impact during use, which means can be consulted during maintenance operations.

The invention achieves this object by means of a device for detecting and recording impacts along several axes of an aeronautic propeller blade, characterized in that it comprises an accelerometer integrated at the center of an aeronautic propeller blade root and an electronic module to record, during its entire service life, any occurrence of impact at various predetermined levels.

Advantageously, the device comprises an accelerometer with at least two axes integrated at the top of the blade equilibration device and it records impacts in two planes perpendicular to the axis of the blade.

The accelerometer signals can be transmitted remotely to an electronic module situated in any location whatever, and which makes the recordings; however, advantageously, the electronic module (and all its attached elements such as the power supply that also serves the accelerometer) can also be integrated into the root of the blade, so that the device forms a completely autonomous unit integrated into the blade.

Thus, according to the invention, in order to monitor, count and record abnormal impacts, a 2- or 3-axis accelerometer is integrated, which is connected to an autonomous electronic module supplying the accelerometer, recovering the data sent back from the accelerometer, so as to compare the data to predetermined levels, storing occurrences beyond predetermined levels in memory and integrating a memory reading device, either by direct connection, or by UHF remote transmission.

The invention therefore proposes integrating at the root of the blade a completely autonomous system for measuring and recording impacts beyond predefined thresholds, so as to monitor by interrogating the system, the number of cases encountered in use for the different predefined thresholds.

The invention will be better understood and the other advantages and characteristics will become apparent upon reading the following description referring to the attached drawings in which:

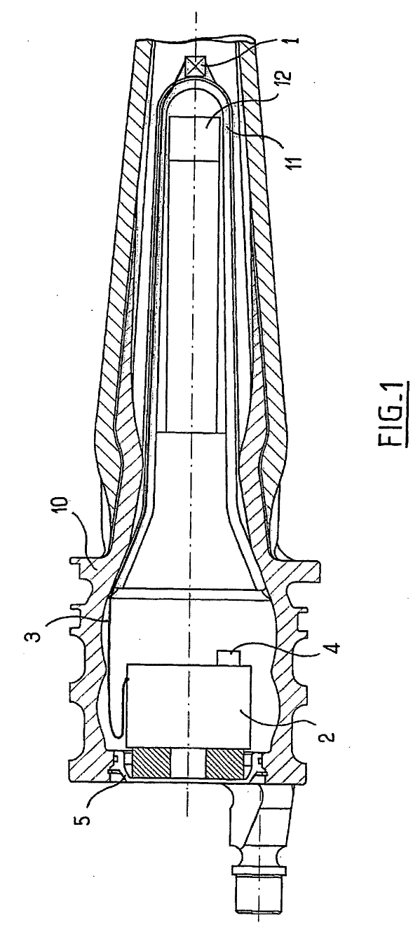

FIG. 1 is a sectional view of a propeller blade root showing the implantation of the electronic sensor/module system,

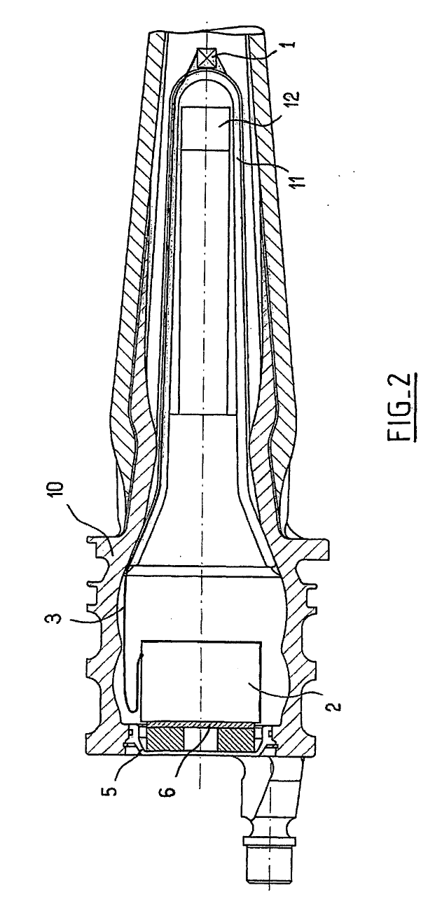

FIG. 2 is a variant of FIG. 1 at the level of the reading means for the electronic module,

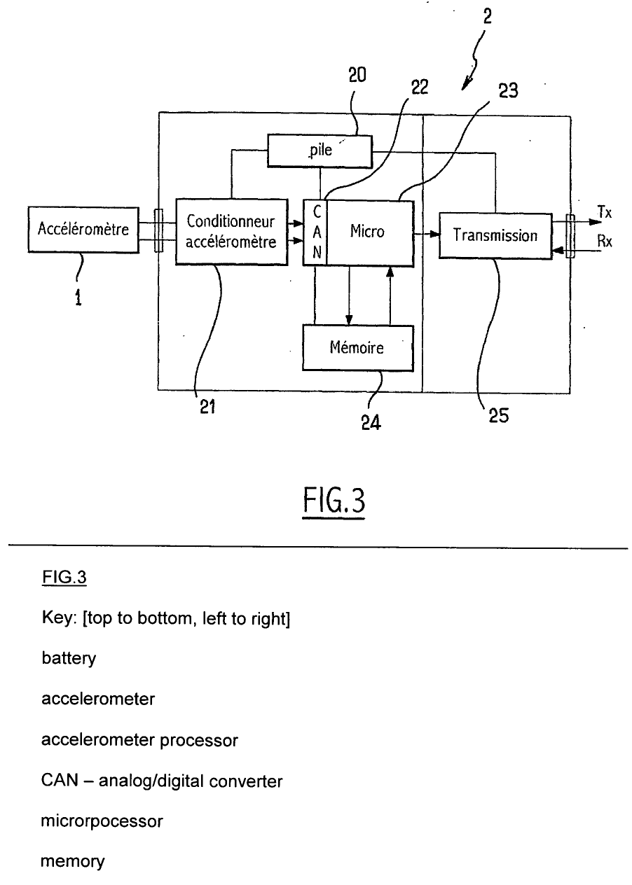

FIG. 3 is a diagram of the electronic module.

FIGS. 1 and 2 show one example of implantation of the impact sensor (accelerometer) and the electronic module in an aeronautic propeller root 10. The device of the invention comprises, on the one hand, an accelerometer 1 with 2 or 3 axes, attached to the end of part 11 connected to propeller root 10 and receiving equilibration weights 12 of the blade, and, on the other hand, an autonomous electronic module 2, of one piece with a cover 5 for access to the zone for equilibration and connected to accelerometer 1 via connection wires 3.

FIG. 1 shows an electronic module 2 integrating a connector 4 for the function of reading the memories of module 2, requiring a removal of cover 5 for this function; the major appeal of this version is its autonomy which is associated with the very low energy consumption of the electronic module.

FIG. 2 presents an electronic module integrating a device for UHF connection with an antenna 6 permitting remote reading through cover 5, thus eliminating the necessity of removing this cover during this operation.

FIG. 3 diagrams electronic module 2 comprising a power supply 20 by means of a lithium-type battery, for example, a circuit 21 assuring the processing of the accelerometer signals, processing of the data or feeding it back via an analog/digital converter 22, a microprocessor 23 and a permanent memory 24 permitting storing the number of occurrences of impacts for each predefined level for each axis of accelerometer 1, in the form of a table. In order to equip the embodiment of FIG. 2, module 2 also comprises a transmission unit 25 to communicate with a transmitter Tx or a receiver Rx.

1-5. (canceled)

6. A device for detecting and recording impacts along several axes of an aeronautic propeller blade having a root, the device comprising:
an accelerometer integrated at a center of the root of the aeronautic propeller blade; and
an electronic module to record, during a service life of the aeronautic propeller blade, any occurrence of the impacts at predetermined levels.

7. The device of claim 6, wherein said electronic module is integrated into the root of the aeronautic propeller blade.

8. The device of claim 6, wherein said accelerometer is directly connected to said electronic module for reading of the recording.

9. The device of claim 6, wherein said accelerometer is remotely connected with said electronic module for reading of the recording, and wherein said remote connection uses UHF signals.

10. The device of claim 6, further comprising a blade equilibration device, wherein said accelerometer has at least two axes integrated at a top of said blade equilibration device, and wherein the device records impacts in two planes perpendicular to the axis of the aeronautic propeller blade.

11. The device of claim 10, wherein said accelerometer is directly connected to said electronic module for reading of the recording.

12. The device of claim 10, wherein said accelerometer is remotely connected with said electronic module for reading of the recording, and wherein said remote connection uses UHF signals.

13. The device of claim 10, further comprising an antenna operably connected with said electronic module for remote reading of the recording.

14. The device of claim 10, wherein said electronic module is integrated into the root of the aeronautic propeller blade.

15. The device of claim 14, wherein said accelerometer is directly connected to said electronic module for reading of the recording.

16. The device of claim 14, wherein said accelerometer is remotely connected with said electronic module for reading of the recording, and wherein said remote connection uses UHF signals.

17. A device for detecting and recording impacts along several axes of an aeronautic propeller blade having a root, the device comprising:
an accelerometer integrated at a center of the root of the aeronautic propeller blade; and
an electronic module to record, during a service life of the aeronautic propeller blade, any occurrence of the impacts at predetermined levels, wherein said electronic module has a power supply, a circuit for the processing of accelerometer signals, an analog/digital converter, a microprocessor and a memory for storing the number of occurrences of the impacts.

18. The device of claim 17, further comprising a blade equilibration device, wherein said accelerometer has at least two axes integrated at a top of said blade equilibration device, and wherein the device records impacts in two planes perpendicular to the axis of the aeronautic propeller blade.

19. The device of claim 17, wherein said electronic module is integrated into the root of the aeronautic propeller blade.

20. The device of claim 19, wherein said accelerometer is directly connected to said electronic module for reading of the recording.

21. The device of claim 19, wherein said accelerometer is remotely connected with said electronic module for reading of the recording, and wherein said remote connection uses UHF signals.

22. A method of detecting and recording impacts along several axes of an aeronautic propeller blade comprising:
obtaining data representative of the impacts via an accelerometer integrated with the aeronautic propeller blade;
communicating said data from said accelerometer to an electronic module;
comparing said data to predetermined levels;
storing occurrences of the impacts beyond said predetermined levels in memory; and
providing for reading of the number of said occurrences via a memory reading device.

23. The method of claim 22, wherein said memory reading device receives signals representative of the number of said occurrences via a direct connection.

24. The method of claim 22, wherein said memory reading device receives signals representative of the number of said occurrences via remote transmission.

25. The method of claim 24, wherein said remote transmission is via UHF.
